(19) United States
(12) Patent Application Publication
(10) Pub. No.: US 2020/0318701 A1
(43) Pub. Date: Oct. 8, 2020

(54) BRAKING DEVICE

(71) Applicant: EXEDY Corporation, Osaka (JP)

(72) Inventor: Shinya HISATA, Osaka (JP)

(73) Assignee: EXEDY Corporation

(21) Appl. No.: 16/791,608

(22) Filed: Feb. 14, 2020

(30) Foreign Application Priority Data
Apr. 3, 2019 (JP) 2019-071503

(51) Int. Cl. F16D 65/84; F16D 55/40

(52) U.S. Cl. CPC F16D 65/84; F16D 2065/788; F16D 55/40

(57) ABSTRACT

A braking device configured to brake rotation of a shaft of a transmission is disclosed. The braking device includes a housing attachable to a casing of a transmission, a braking part and a lubrication structure. The braking part is disposed in the interior of the housing, and includes a plurality of braking discs. The lubrication structure includes a supply part and a discharge part, and lubricates the braking discs of the braking part. The supply part supplies oil to the interior of the housing, and includes a first supply port that is provided in a member different from the shaft and is disposed radially inside the braking part. The discharge part discharges the oil, supplied to the interior of the housing, to the casing of the transmission, and includes a discharge flow pathway that axially extends and is provided on the outer peripheral side of the plurality of braking discs.

### CROSS-REFERENCE TO RELATED APPLICATIONS

This application claims priority to Japanese Patent Application 2019-071503, filed Apr. 3, 2019. The contents of that application are incorporated by reference herein in their entirety.

### TECHNICAL FIELD

The present invention relates to a braking device, particularly to a braking device braking a shaft of a transmission.

### BACKGROUND ART

In a type of transmission for vehicles, a main shaft and a counter shaft are disposed in parallel to each other in the interior of a casing. Additionally, a plurality of main gears provided on the main shaft and a plurality of counter gears provided on the counter shaft are constantly meshed with each other. In attempt to perform gear shifting, this type of transmission is required to change, as a gear pair through which power is transmitted, from one pair to another pair among the plurality of pairs of main and counter gears. In actual gear shifting, one main gear, included in one gear pair through which power is now being transmitted, is decoupled from the main shaft. Then, another main gear, included in another gear pair through which power is subsequently transmitted, is coupled to the main shaft, while the main shaft is synchronized in rotation with the another gear pair.

A synchronous mechanism is provided for the aforementioned synchronous control executed in performing gear shifting. Besides, a counter shaft brake has been also proposed as described in Japan Laid-open Patent Application Publication No. 2001-263457. The counter shaft brake is provided with a friction material for braking, and requires cooling and lubrication for the friction material.

In view of this, the counter shaft brake, described in Japan Laid-open Patent Application Publication No. 2001-263457, is provided with an oil introducing pathway and an oil discharging pathway on the outer peripheral side of the counter shaft brake. In the counter shaft brake, oil scooped up by rotation of the gears is led to the oil introducing pathway, and is discharged from the oil discharging pathway after cooling and lubricating the friction material.

The counter shaft brake, described in Japan Laid-open Patent Application Publication No. 2001-263457, is provided with the oil introducing pathway and the oil discharging pathway on the outer peripheral side of the counter shaft brake. Because of this, a large space is required on the outer peripheral side of the friction material. Besides, a complicated configuration is required for introducing and discharging the oil.

### BRIEF SUMMARY

It is an object of the present invention to provide a braking device, in which cooling and lubrication can be sufficiently done, with a simple configuration without enlarging a radial space of the braking device.

(1) A braking device according to the present invention is a device braking rotation of a shaft of a transmission. The braking device includes a housing, a braking part and a lubrication structure. The housing is attachable to a casing of the transmission. The braking part is disposed in an interior of the housing, and includes a plurality of braking discs. The lubrication structure lubricates the plurality of braking discs of the braking part. Additionally, the lubrication structure includes a supply part and a discharge part. The supply part supplies an oil to the interior of the housing, and includes a first supply port that is provided in a member different from the shaft and is disposed radially inside the braking part. The discharge part discharges the oil supplied to the interior of the housing to the casing of the transmission, and includes a discharge flow pathway that axially extends and is provided on an outer peripheral side of the plurality of braking discs.

In the present braking device, the braking part is actuated whereby rotation of the shaft is braked. Additionally, the oil is supplied to the interior of the housing from the first supply port provided radially inside the braking part. The oil is then supplied to the braking part by centrifugal force, and cools and lubricates the braking part. After cooling and lubricating the braking part, the oil is discharged to the casing of the transmission through the discharge flow pathway provided on the outer peripheral side of the plurality of braking discs.

In the present braking device, the oil is supplied from radially inside the braking part and is then scattered by centrifugal force. The scattered oil is discharged as it is to the casing of the transmission through the discharge flow pathway provided on the outer peripheral side of the plurality of braking discs. Therefore, the configuration to supply the oil to the interior of the housing and then discharge the oil therefrom is made simple, and simultaneously, lubrication can be sufficiently done. Moreover, the oil is discharged through the axially extending discharge flow pathway provided on the outer peripheral side of the plurality of braking discs. Hence, unlike a well-known device, it is not required to provide a space or discharge pathway for discharging the oil to an outer peripheral part of the braking device. Because of this, the radial space of the braking device can be made compact.

Besides, the first supply port is provided in the member different from the shaft. Hence, the shaft is not required to be provided with a hole for supplying the oil. Because of this, reduction in strength of the shaft can be prevented.

(2) Preferably, the first supply port is provided in the housing. In this case, the lubrication structure can be realized with a simple configuration, because the first supply port is provided in the housing.

(3) Preferably, the lubrication structure includes a housing flow pathway that is provided in the housing and leads the oil to the first supply port.

Here, the oil supplied from outside is led to the first supply port through the housing flow pathway, and is then supplied to the interior of the housing from the first supply port. In this case, flexibility in design of the configuration for supplying the oil to the housing is enhanced, because the oil can be led to the first supply port through the housing flow pathway.

(4) Preferably, the housing includes an attachment surface enabled to make contact with the casing of the transmission, and the attachment surface is provided with an intake port taking the oil therethrough into the housing flow pathway.

Here, the oil is taken into the housing flow pathway through the intake port provided in the attachment surface of the housing. Because of this, the configuration to introduce the oil to the braking device is made simple.

(5) Preferably, the housing further includes a disc portion and a center boss. The disc portion is disposed in opposition to the casing of the transmission. The center boss extends toward the interior of the housing in a middle of the disc portion. Besides, preferably, the plurality of braking discs are supported to be axially movable on the outer peripheral side of the center boss, and the first supply port is provided in a distal end of the center boss.

In this case, the oil is supplied from the first supply port provided in the center boss disposed in the middle of the disc portion. In other words, the oil is supplied from an approximately middle part of the braking device. Because of this, the oil can be efficiently supplied to the braking part.

(6) Preferably, the braking device further includes a center member coupled to the shaft. The center member includes a tubular portion disposed radially inside the braking part.

Here, when the first supply port is provided on the inner peripheral side of the tubular portion of the center member, the oil supplied to the interior of the housing can be temporarily received by the tubular portion of the center member. Then, the oil received by the tubular portion can be supplied to the braking part. Because of this, the oil can be sufficiently supplied to the braking part.

(7) Preferably, the lubrication structure supplies the oil from an inner peripheral side of the tubular portion of the center member. In this case, similarly to the above, the oil supplied to the interior of the housing can be temporarily received by the tubular portion of the center member, and can be then sufficiently supplied to the braking part.

(8) Preferably, the lubrication structure includes a plurality of radial flow pathways radially penetrating the tubular portion of the center member.

The oil, residing on the inner peripheral side of the tubular portion, passes through the plurality of radial flow pathways, and is supplied to the braking part.

(9) Preferably, the plurality of radial flow pathways are provided in helix alignment in the tubular portion. In this case, the oil, flowing through the tubular portion, can be uniformly supplied to the braking part.

(10) Preferably, the supply part of the lubrication structure includes a second supply port that is provided in the center member and is disposed radially inside the braking part.

Here, the oil can be supplied to the interior of the housing through the second supply port provided in the center member. Therefore, the oil supplied through the second supply port can more sufficiently cool and lubricate the braking part together with the oil supplied through the first supply port.

(11) Preferably, the lubrication structure includes a plurality of axial flow pathways provided in the center member, and each of the plurality of axial flow pathways is provided with the second supply port in a distal end thereof.

Here, the oil can be supplied to the interior of the housing from the second supply port through the plurality of axial flow pathways provided in the center member.

(12) Preferably, the discharge part is provided in the housing. In this case, the configuration to discharge the oil is made simple.

(13) Preferably, the housing includes a tubular portion that extends inside the casing of the transmission and is enabled to be accommodated in the casing of the transmission. Besides, the discharge part includes a plurality of discharge ports that are provided to radially penetrate the tubular portion of the housing.

In this case, the configuration to discharge the oil is made simple, and besides, the oil can be discharged with a small radial space. Moreover, after cooling and lubricating the braking part, the oil is discharged from the plurality of discharge ports provided in an outer peripheral portion of the housing, i.e., the tubular portion. Hence, it is possible to efficiently flow the oil with respect to the braking part.

(14) Preferably, the plurality of discharge ports are disposed to be circumferentially displaced from each other.

Here, after cooling and lubricating the braking part, the oil can be efficiently discharged to a space produced on the outer peripheral side of the braking part.

(15) Preferably, the housing includes the tubular portion that axially extends and accommodates the braking part in an interior thereof. Besides, the discharge flow pathway is provided in the tubular portion.

In this case, after cooling and lubricating the braking part, the oil can be efficiently discharged to the outer peripheral side of the braking part, and further, can be smoothly discharged to the casing of the transmission. Moreover, the braking part can be cooled through the tubular portion.

(16) Preferably, the tubular portion extends inside the casing of the transmission, and is enabled to be accommodated in the casing of the transmission.

In this case, after cooling and lubricating the braking part, the oil can be smoothly discharged to the casing of the transmission.

(17) Preferably, the discharge flow pathway is provided on an outer peripheral surface of the tubular portion of the housing. In this case, the discharge flow pathway is made simple in configuration.

(18) Preferably, the discharge flow pathway is a gap produced between the outer peripheral surface of the tubular portion and an inner surface of the casing of the transmission. In this case, the discharge flow pathway is made simpler in configuration.

Overall, in the braking device according to the present invention described above, cooling and lubrication can be sufficiently done with a simple configuration without enlarging a radial space of the braking device.

### BRIEF DESCRIPTION OF THE DRAWINGS

FIG. 1 is a cross-sectional view of a counter shaft brake according to a preferred embodiment of the present invention.

FIG. 2 is an external perspective view of the counter shaft brake shown in FIG. 1.

FIG. 3 is a view of a braking part extracted from the counter shaft brake shown in FIG. 1.

FIG. 4 is a view of a lubrication structure of the counter shaft brake shown in FIG. 1.

FIG. 5 is a view showing a lubrication path.

### DETAILED DESCRIPTION

### [Entire Configuration]

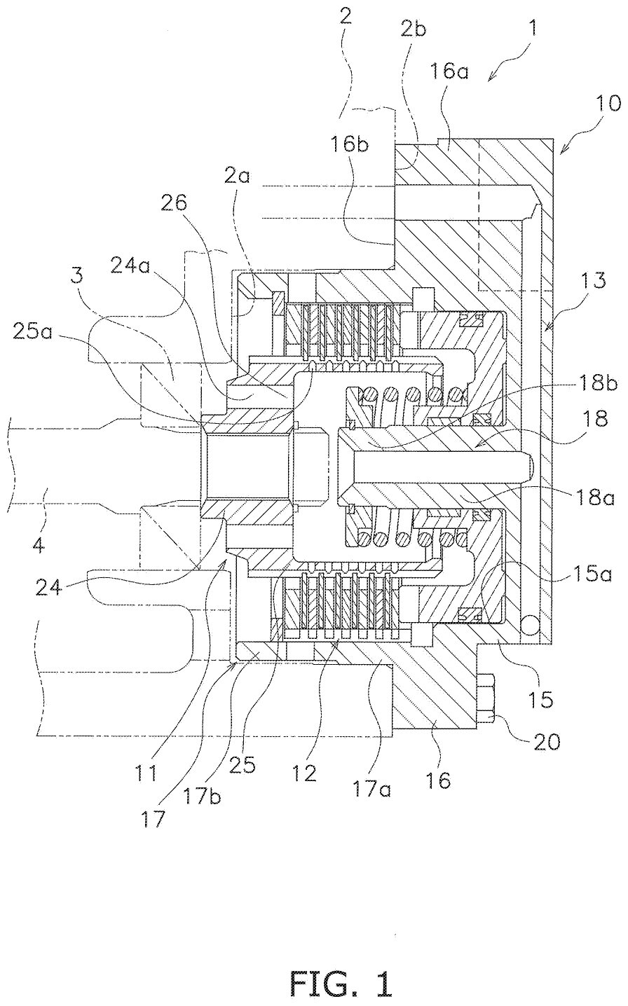

FIG. 1 shows a counter shaft brake 1 (an example of a braking device) according to a preferred embodiment of the present invention. The counter shaft brake 1 is attached to the rear end of a transmission casing 2. The counter shaft brake 1 is attached to a shaft 4 (e.g., a counter shaft or an extended shaft of the counter shaft) rotatably supported by the transmission casing 2 through a bearing 3 (e.g., a ball bearing), and is configured to brake the rotational speed of the shaft 4. In more detail, the transmission casing 2 is provided with an accommodation portion 2a dented inward on the rear end thereof. The counter shaft brake 1 is attached to the rear end of the transmission casing 2, while being accommodated in part in the accommodation portion 2a. The following explanation will be described based on an assumption that the counter shaft brake 1 has been attached to the transmission casing 2. It should be noted that the bearing 3 has a gap for enabling oil to pass therethrough in an axial direction. Hence, as described below, the bearing 3 also functions as a flow pathway of the oil.

It should be noted that in the following explanation, the term “radially outward (or inward)” means a side separating from (or approaching to) a rotational axis of the shaft 4. On the other hand, the term “axial direction” means a direction arranged along the rotational axis of the shaft 4.

The counter shaft brake 1 includes a housing 10, a hub 11 (an example of a center member), a braking part 12 and a lubrication structure 13.

### [Housing 10]

The housing 10 includes a disc portion 15, an attachment portion 16 having an annular shape, a first tubular portion 17 and a center boss 18.

The disc portion 15 is disposed outside the transmission casing 2, and is opposed to the transmission casing 2. The disc portion 15 is provided with a cylinder portion 15a in the interior thereof.

The attachment portion 16 is provided in the outer peripheral part of the disc portion 15. The attachment portion 16 is provided with a plurality of attachment holes (not shown in the drawings). The housing 10 is fixed to a rear end surface 2b of the transmission casing 2 by a plurality of bolts 20 penetrating the attachment holes. Additionally, the attachment portion 16 is provided with a flow pathway provided portion 16a. The flow pathway provided portion 16a is axially thicker than the other part of the attachment portion 16. In other words, the flow pathway provided portion 16a is axially wider than the other part of the attachment portion 16. The attachment portion 16 makes close contact at an axial end surface 16b thereof (an example of an attachment surface) with the rear end surface 2b of the transmission casing 2.

The first tubular portion 17 extends to axially protrude on the inner peripheral side of the attachment portion 16, and is fitted into the accommodation portion 2a of the transmission casing 2. The first tubular portion 17 is provided with internal teeth on the inner peripheral surface thereof.

The first tubular portion 17 includes a fitting portion 17a, provided in part of the base end-side (disc portion-side) part thereof, and a flow pathway provided portion 17b. The fitting portion 17a has an approximately equal diameter to the inner peripheral surface of the accommodation portion 2a, and is fitted into the accommodation portion 2a approximately without a gap. The flow pathway provided portion 17b has a smaller diameter than the fitting portion 17a, and produces, together with the inner peripheral surface of the accommodation portion 2a, a predetermined gap therebetween.

The center boss 18 is provided in the middle of the disc portion 15, and extends toward the counter shaft 4 along the axis of the counter shaft 4. The center boss 18 has a circular cross section, and includes a support portion 18a and a distal end portion 18b. The support portion 18a has a larger diameter than the distal end portion 18b.

### [Hub 11]

The hub 11 is fixed to the counter shaft 4 while being axially immovable and non-rotatable relative thereto. In other words, the hub 11 is rotated in synchronization with the counter shaft 4.

The hub 11 includes a fixation portion 24 having a disc shape and a second tubular portion 25. The fixation portion 24 is attached to the distal end of the counter shaft 4 by, for instance, spline coupling. The fixation portion 24 is provided with a plurality of holes 24a axially penetrating therethrough. The holes 24a function as an axial flow pathway. Additionally, the distal ends (right ends in FIG. 1) of the holes 24a function as supply ports 26 (an example of second supply ports), from which the oil is supplied to the interior of the housing 10. The second tubular portion 25 extends axially outward (toward the disc portion 15 of the housing 10) from the outer peripheral part of the fixation portion 24. The second tubular portion 25 is provided with a plurality of external teeth on the outer peripheral surface thereof.

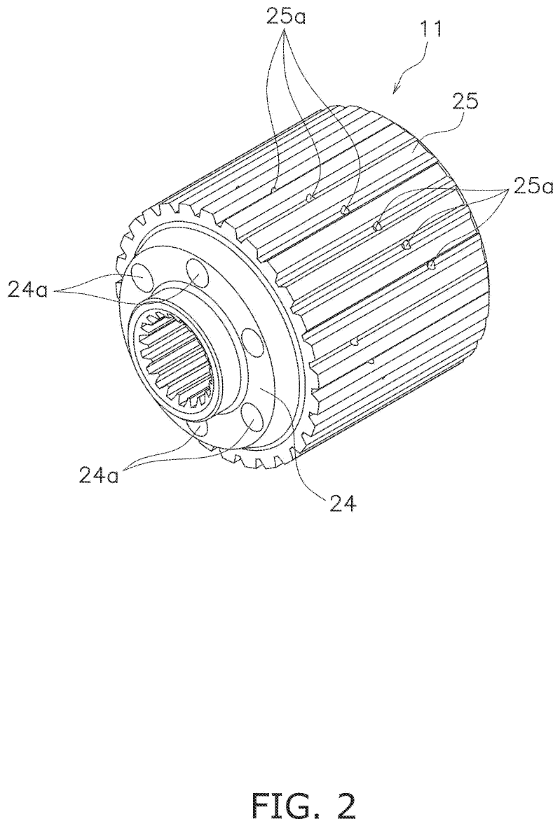

Besides, as shown in FIGS. 1 and 2, the second tubular portion 25 is provided with a plurality of holes 25a radially penetrating therethrough. The plural holes 25a are circumferentially aligned with each other, while being axially displaced from each other. In other words, the plural holes 25a are provided in helix alignment. The holes 25a function as a radial flow pathway.

### [Braking Part 12 and Actuation Mechanism Thereof]

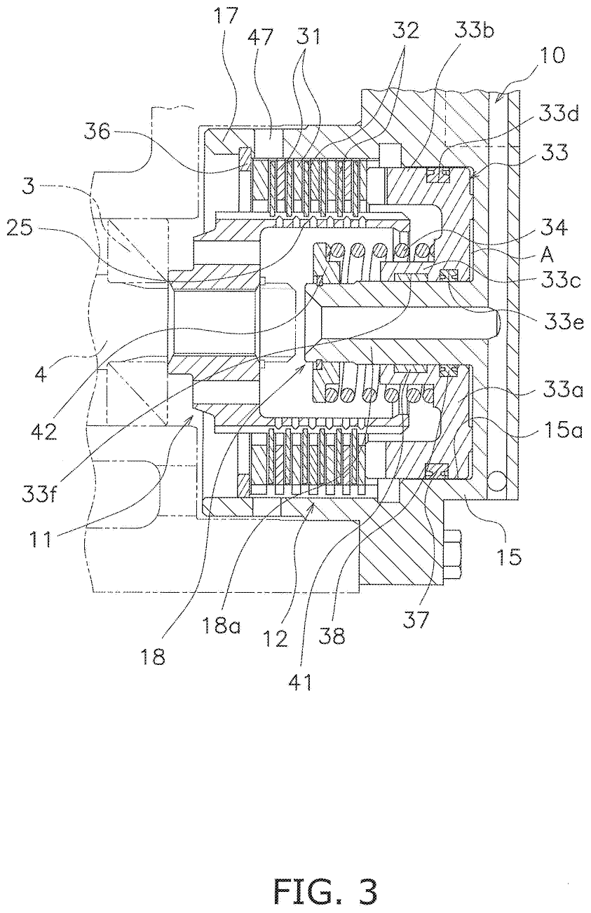

As shown in FIG. 3, the braking part 12 is disposed in the interior of the housing 10. In more detail, the braking part 12 is disposed radially between the first tubular portion 17 of the housing 10 and the second tubular portion 25 of the hub 11. The braking part 12 includes a plurality of first discs 31 and a plurality of second discs 32.

Besides, a piston 33 and a return spring 34 are provided for actuating the braking part 12.

Each first disc 31 has an annular shape, and is provided with external teeth on the outer peripheral surface thereof. The external teeth are meshed with the internal teeth of the first tubular portion 17. Therefore, each first disc 31 is non-rotatable but axially movable relative to the housing 10.

The second discs 32 are disposed such that each is interposed between adjacent two of the first discs 31. Each second disc 32 has an annular shape and is provided with internal teeth on the inner peripheral surface thereof. The internal teeth are meshed with the external teeth of the second tubular portion 25. Therefore, each second disc 32 is non-rotatable but axially movable relative to the hub 11. Additionally, friction materials are fixed to the both lateral surfaces of each second disc 32.

It should be noted that a stop ring 36 is fixed to the inner peripheral surface of the distal end of the first tubular portion 17 of the housing 10. The stop ring 36 restricts axial movement of the first and second discs 31 and 32.

The piston 33 for actuating the braking part 12 is disposed in the cylinder portion 15a provided in the disc portion 15 of the housing 10. The piston 33 has an annular shape and includes a disc portion 33a, an outer peripheral tubular portion 33b and an inner peripheral tubular portion 33c. The outer peripheral tubular portion 33b extends axially inward (toward the counter shaft 4) from the outer peripheral part of the disc portion 33a, and is movable along the inner peripheral surface of the cylinder portion 15a. The inner peripheral tubular portion 33c extends axially inward from the inner peripheral part of the disc portion 33a, and is movable along the support portion 18a of the center boss 18 of the housing 10.

The outer peripheral tubular portion 33b is provided with a groove 33d having an annular shape on the outer peripheral surface thereof, while the inner peripheral tubular portion 33c is provided with a groove 33e having an annular shape on the inner peripheral surface thereof. Besides, seal members 37 and 38 are attached to the grooves 33d and 33e, respectively. Therefore, an air chamber A, i.e., a sealed space to which air is introduced, is formed between the disc portion 33a of the piston 33 and the lateral surface of the cylinder portion 15a of the housing 10.

It should be noted that the inner peripheral tubular portion 33c is provided with another groove 33f having an annular shape on the inner peripheral surface thereof. A wear ring 41, functioning as a bearing, is attached to the groove 33f The wear ring 41 enables the piston 33 to smoothly move in the axial direction.

The return spring 34 is a spring for returning the piston 33 to a position shown in FIGS. 1 and 3. A stopper ring 42 is fixed to the distal end of the center boss 18, and the return spring 34 is disposed between the stopper ring 42 and the disc portion 33a of the piston 33. Therefore, the piston 33 is constantly stationed to the position shown in FIGS. 1 and 3 in a condition that air has not been introduced to the air chamber A.

### [Lubrication Structure 13]

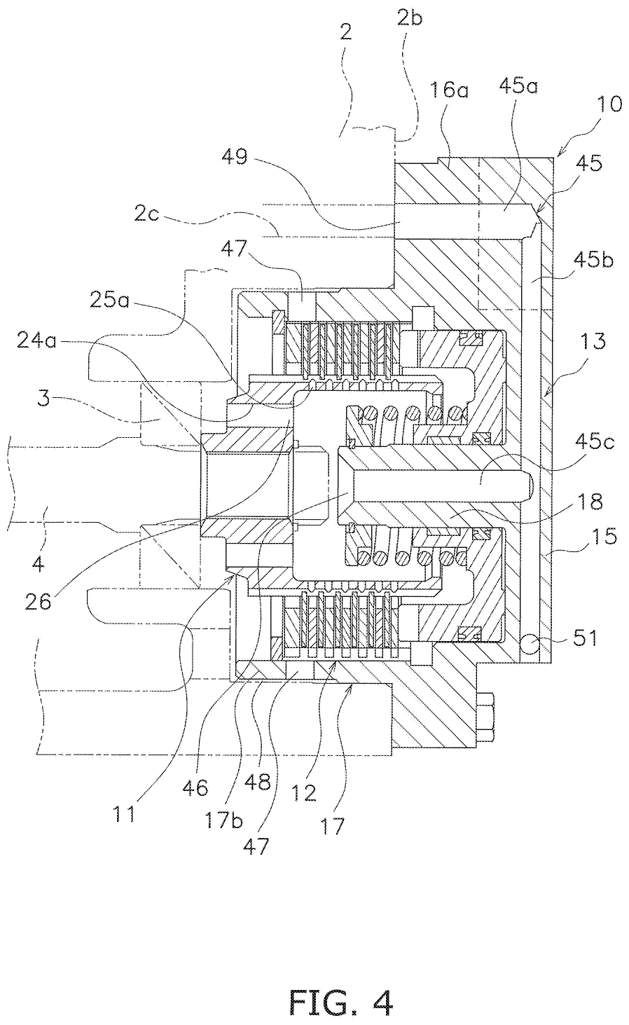

The lubrication structure 13 includes a supply part and a discharge part. The lubrication structure 13 supplies the oil to the interior of the housing 10 from radially inside of the braking part 12, and discharges the oil residing in the interior of the housing 10 from radially outside the braking part 12. As shown in FIG. 4, the lubrication structure 13 includes a housing flow pathway 45, a supply port 46 (an example of a first supply port composing part of a supply part), a plurality of discharge ports 47 (an example of at least one discharge port composing part of a discharge part) and a discharge flow pathway 48, all of which are provided in the housing 10. Besides, as described above, the lubrication structure 13 includes the plural radial flow pathways 25a and the plural second supply ports 26 (an example of a second supply port composing part of the supply part), both of which are provided in the hub 11.

The housing flow pathway 45 includes an outer peripheral flow pathway 45a, a connecting flow pathway 45b and a middle flow pathway 45c.

The outer peripheral flow pathway 45a is provided to axially extend in the flow pathway provided portion 16a of the housing 10. The outer peripheral flow pathway 45a includes an intake port 49 in the distal end thereof. The intake port 49 faces the rear end surface 2b of the transmission casing 2. The oil is taken into the outer peripheral flow pathway 45a from an oil pathway 2c provided on the transmission side through the intake port 49.

The connecting flow pathway 45b is provided to radially extend in the disc portion 15 of the housing 10. One end of the connecting flow pathway 45b is connected to the outer peripheral flow pathway 45a. It should be noted that the other end of the connecting flow pathway 45b is enclosed by a ball 51.

The middle flow pathway 45c is provided in the center boss 18. One end of the middle flow pathway 45c is connected to the connecting flow pathway 45b. On the other hand, the other end (i.e., the distal end) of the middle flow pathway 45c includes the first supply port 46. Accordingly, the first supply port 46 is located radially inside the second tubular portion 25 of the hub 11.

The plural discharge ports 47 are provided in the first tubular portion 17 of the housing 10. In more detail, the discharge ports 47 are provided to radially penetrate the flow pathway provided portion 17b of the first tubular portion 17. Besides, the discharge ports 47 are provided to be circumferentially aligned with each other (in other words, circumferentially displaced from each other). When the oil is scattered by centrifugal force and passes through the braking part 12, the discharge ports 47 lead the oil to a space located on the outer peripheral side of the first and second discs 31 and 32.

The discharge flow pathway 48 is provided on the outer peripheral part of the first tubular portion 17 of the housing 10. In more detail, as described above, the first tubular portion 17 includes the flow pathway provided portion 17b having a smaller diameter than the fitting portion 17a. Additionally, a predetermined gap is produced between the outer peripheral surface of the flow pathway provided portion 17b and the inner peripheral surface of the accommodation portion 2a of the transmission casing 2. The gap functions as the discharge flow pathway 48. In other words, the discharge flow pathway 48 is provided on the outer peripheral side of the both types of discs 31 and 32 of the braking part 12, while axially extending toward the interior of the transmission casing 2. Therefore, after cooling and lubricating the both types of discs 31 and 32, the oil is returned to the interior of the transmission casing 2 through the discharge flow pathway 48.

### [Action]

In gear shifting, when reduction in rotational speed of the counter shaft 4 is required, air is supplied to the air chamber A. Accordingly, the piston 33 is actuated against the urging force of the return spring 34, and is moved to the left side in FIG. 1. Because of this, the first discs 31 and the second discs 32 are pressed against each other, whereby rotation of the hub 11 fixed to the counter shaft 4 is braked. In other words, rotation of the counter shaft 4 is braked.

Additionally, when air is stopped from being introduced into the air chamber A, the piston 33 is returned to the initial position thereof (the position shown in FIG. 1) by the return spring 34. Because of this, the first discs 31 and the second discs 32 are released from being pressed against each other, whereby braking of the hub 11 and the counter shaft 4 is released.

In the action described above, the braking part 12 is cooled and lubricated by the oil supplied thereto from the transmission side.

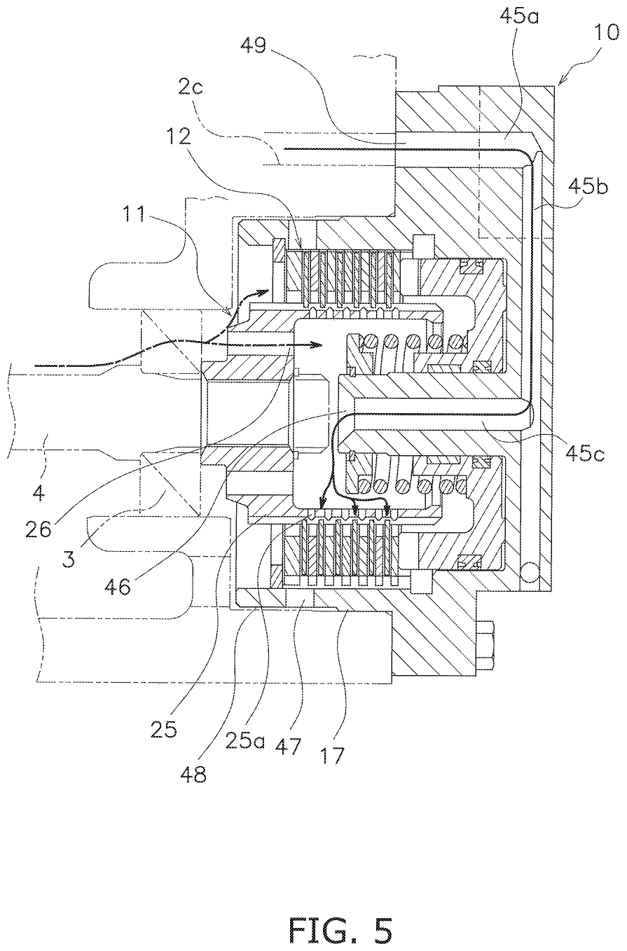

First, as depicted with solid line in FIG. 5, the oil, pressurized and fed by an oil pump through the oil pathway 2c provided on the transmission side, is taken into the interior of the housing 10 from the intake port 49 of the housing 10. The oil, taken into the interior of the housing 10, passes through the outer peripheral flow pathway 45a, the connecting flow pathway 45b and the middle flow pathway 45c in this order, and is supplied to the inner peripheral space of the housing 10 from the supply port 46.

The oil, supplied to the inner peripheral space of the housing 10, is received by the inner peripheral part of the second tubular portion 25 of the hub 11, and is spread over the entire circumference of the inner peripheral part of the second tubular portion 25 by centrifugal force. Furthermore, the oil passes through the radial flow pathways 25a, and is supplied to the braking part 12. The oil, supplied to the braking part 12, cools and lubricates the braking part 12, and is discharged to the outside of the housing 10 through the discharge ports 47 provided in the first tubular portion 17 of the housing 10. Then, the oil, discharged to the outside of the housing 10, returns to the interior of the transmission casing 2 through the discharge flow pathway 48.

The oil is also supplied through a path depicted with dashed dotted line in FIG. 5 in addition to the oil flow path described above. Specifically, the bearing 3, supporting the counter shaft 4, is being rotated. Hence, the oil, residing in the interior of the transmission casing 2, is supplied to the hub 11 side by a pump effect of the bearing 3. The oil, supplied to the hub 11 side, is supplied to the braking part 12 along the lateral surface of the hub 11, and is also supplied to the inner peripheral side of the second tubular portion 25 of the hub 11 through the axial flow pathways 24a of the hub 11 and the second supply ports 26 as the outlets of the axial flow pathways 24a. The oil, supplied to the inner peripheral side of the second tubular portion 25 of the hub 11, cools and lubricates the braking part 12 through the oil flow path depicted with solid line.

### Other Preferred Embodiments

The present invention is not limited to the preferred embodiment described above, and a variety of changes or modifications can be made without departing from the scope of the present invention.

(a) The aforementioned preferred embodiment has exemplified the configuration that the hub is fixed to the counter shaft. However, the present invention is similarly applicable even to a configuration that the counter shaft is provided with external teeth on the outer peripheral surface thereof, and the second discs are meshed with the external teeth.

(b) In the aforementioned preferred embodiment, the first supply port is provided in the housing, whereas the second supply port is provided in the hub. However, the configurations of these supply ports are not particularly limited as long as these supply ports are provided in a member other than the shaft and are disposed radially inside the braking part.

(c) The aforementioned preferred embodiment has exemplified the configuration that the present device is attached to the counter shaft. However, the present invention is similarly applicable even to a configuration that the present device is attached to the extended shaft of the counter shaft.

(d) The aforementioned preferred embodiment has exemplified the configuration that the plural discharge ports are provided. However, as long as at least one discharge port is provided, the number of discharge ports is not particularly limited. Besides, the axial position of the discharge ports is not limited to that in the aforementioned preferred embodiment.

(e) In the aforementioned preferred embodiment, a gap, produced between the outer peripheral surface of the first tubular portion 17 of the housing 10 and the inner peripheral surface of the accommodation portion 2a of the transmission casing 2, is defined as the discharge flow pathway 48. However, the configuration of the discharge flow pathway is not limited to this. For example, a plurality of grooves can be provided, as the discharge flow pathway, on the outer peripheral surface of the first tubular portion 17, while axially extending and communicating with the discharge ports 47. Alternatively, the inner peripheral surface of the first tubular portion 17, i.e., grooves provided on a part meshed with the outer peripheral parts of the first discs 31, can be utilized as the discharge flow pathway.

(f) The configuration of the braking part is not limited to that in the aforementioned preferred embodiment, and a variety of changes can be made for the configuration.

(g) It should be noted that an annular groove can be provided on the fitting portion 17a of the first tubular portion 17 of the housing 10, and a seal member can be attached to the annular groove.

### REFERENCE SIGNS LIST

1 Counter shaft brake
2 Transmission casing
4 Counter shaft
10 Housing
11 Hub (center member)
12 Braking part
13 Lubrication structure
15 Disc portion
17 First tubular portion
18 Center boss
24a Axial flow pathway
25 Second tubular portion
25a Radial flow pathway
26 Second supply port
31 First disc
32 Second disc
46 First supply port
47 Discharge port
48 Discharge flow pathway
49 Intake port

What is claimed is:

1. A braking device configured to brake rotation of a shaft of a transmission, the braking device comprising:
a housing attachable to a casing of the transmission;
a braking part disposed in an interior of the housing, the braking part including a plurality of braking discs; and
a lubrication structure configured to lubricate the plurality of braking discs of the braking part, wherein
the lubrication structure includes
a supply part configured to supply an oil to the interior of the housing, the supply part including a first supply port, the first supply port provided in a member different from the shaft, the first supply port disposed radially inside the braking part, and
a discharge part configured to discharge the oil supplied to the interior of the housing to the casing of the transmission, the discharge part including a discharge flow pathway axially extending, the discharge flow pathway provided on an outer peripheral side of the plurality of braking discs.

2. The braking device according to claim 1, wherein the first supply port is provided in the housing.

3. The braking device according to claim 2, wherein the lubrication structure includes a housing flow pathway, the housing flow pathway provided in the housing, the housing flow pathway configured to lead the oil to the first supply port.

4. The braking device according to claim 3, wherein
the housing includes an attachment surface configured to make contact with the casing of the transmission, and
the attachment surface is provided with an intake port, the intake port configured to take the oil therethrough into the housing flow pathway.

5. The braking device according to claim 1, wherein
the housing further includes
a disc portion opposed to the casing of the transmission, and
a center boss extending toward the interior of the housing in a middle of the disc portion,
the plurality of braking discs are supported to be axially movable on an outer peripheral side of the center boss, and
the first supply port is provided in a distal end of the center boss.

6. The braking device according to claim 1, further comprising:
a center member coupled to the shaft, wherein
the center member includes a tubular portion, the tubular portion disposed radially inside the braking part.

7. The braking device according to claim 6, wherein the lubrication structure is configured to supply the oil from an inner peripheral side of the tubular portion of the center member.

8. The braking device according to claim 6, wherein the lubrication structure includes a plurality of radial flow pathways, the plurality of radial flow pathways radially penetrating the tubular portion of the center member.

9. The braking device according to claim 8, wherein the plurality of radial flow pathways are provided in helix alignment in the tubular portion.

10. The braking device according to claim 6, wherein the supply part of the lubrication structure includes a second supply port, the second supply port provided in the center member, the second supply port disposed radially inside the braking part.

11. The braking device according to claim 10, wherein the lubrication structure includes a plurality of axial flow pathways, the plurality of axial flow pathways provided in the center member, each of the plurality of axial flow pathways provided with the second supply port in a distal end thereof.

12. The braking device according to claim 1, wherein the discharge part is provided in the housing.

13. The braking device according to claim 12, wherein
the housing includes a tubular portion, the tubular portion extending inside the casing of the transmission, the tubular portion configured to be accommodated in the casing of the transmission, and
the discharge part includes a plurality of discharge ports, the plurality of discharge ports provided to radially penetrate the tubular portion of the housing.

14. The braking device according to claim 13, wherein the plurality of discharge ports are disposed to be circumferentially displaced from each other.

15. The braking device according to claim 1, wherein
the housing includes a tubular portion axially extending, the tubular portion accommodating the braking part in an interior thereof, and
the discharge flow pathway is provided in the tubular portion.

16. The braking device according to claim 15, wherein the tubular portion extends inside the casing of the transmission, the tubular portion configured to be accommodated in the casing of the transmission.

17. The braking device according to claim 16, wherein the discharge flow pathway is provided on an outer peripheral surface of the tubular portion of the housing.

18. The braking device according to claim 17, wherein the discharge flow pathway is a gap produced between the outer peripheral surface of the tubular portion and an inner surface of the casing of the transmission.
